(19) United States
(12) Patent Application Publication
(10) Pub. No.: US 2024/0161677 A1
(43) Pub. Date: May 16, 2024

(54) GOA CIRCUIT AND DISPLAY PANEL

(71) Applicants: TCL CHINA STAR OPTOELECTRONICS TECHNOLOGY CO., LTD., Shenzhen (CN); HUIZHOU CHINA STAR OPTOELECTRONICS DISPLAY CO., LTD., Huizhou, Guangdong (CN)

(72) Inventors: Donghun LIM, Shenzhen (CN); Hui YANG, Shenzhen (CN)

(73) Assignee: TCL CHINA STAR OPTOELECTRONICS TECHNOLOGY CO., LTD., Shenzhen (CN)

(21) Appl. No.: 17/780,981

(22) PCT Filed: May 25, 2022
(86) PCT No.: PCT/CN2022/094910

§ 371 Date: May 29, 2022

(30) Foreign Application Priority Data
Apr. 26, 2022 (CN) 202210449189.7

(51) Int. Cl. G09G 3/20

(52) U.S. Cl. CPC G09G 3/2092; G09G 2310/0267; G09G 2310/08

(57) ABSTRACT

The present application provides a GOA circuit and a display panel. The GOA circuit includes a plurality of cascaded GOA units, and an n^{th} stage GOA unit only includes a pull-up control module, a pull-up output module, a pull-down module, and a pull-down maintenance module. Moreover, the pull-down maintenance module receives a clock signal and can pull down a potential of a pull-up node under a control of the clock signal, so as to reduce a working time of the pull-down maintenance module and prolong a working life of the pull-down maintenance module, thereby improving working stability of the GOA circuit.

### BACKGROUND OF INVENTION

### Field of Invention

The present application relates to a field of display technology, and particularly to a GOA circuit and a display panel.

### Description of Prior Art

Gate driver on array (GOA) technology is a driving method that integrates a gate driver circuit onto an array substrate of a display panel to realize progressive scanning. Above driving technology can eliminate gate drivers, and has advantages of reducing production cost and realizing a narrow-frame design of panels, and is used in a variety of display devices. A GOA circuit usually includes a pull-down maintenance module, and the pull-down maintenance module is always in a working state during a pull-down period, which affects a working life of the GOA circuit, thereby affecting working stability of the GOA circuit.

### SUMMARY OF INVENTION

The present application provides a gate driver on array (GOA) circuit and a display panel to solve a technical problem that a pull-down maintenance module of a GOA unit of an existing GOA circuit is always in a working state, which reduces working life of the GOA circuit, thereby affecting working stability of the GOA circuit.

The present application provides a GOA circuit, including a plurality of cascaded GOA units, and an N^{th} stage GOA unit including a pull-up control module, a pull-up output module, a pull-down module, and a pull-down maintenance module;
the pull-up control module receives a control signal and a pull-up signal and is connected to a pull-up node for outputting the pull-up signal to the pull-up node under a control of the control signal and the pull-up signal;
the pull-up output module receives a clock signal and is connected to the pull-up node, an N^{th} stage scanning signal output end, and an N^{th} stage transmission signal output end for outputting an N^{th} stage scanning signal and an N^{th} stage transmission signal under a control of a potential of the pull-up node and the clock signal;
the pull-down module receives an (N+m)^{th} stage transmission signal and a reference low-level signal and is connected to the pull-up node and the N^{th} stage scanning signal output end for pulling down potentials of the pull-up node and the N^{th} stage scanning signal output end under a control of the (N+m)^{th} stage transmission signal and the reference low-level signal; and
the pull-down maintenance module receives a low-frequency clock signal, the clock signal, and the reference low-level signal and is connected to the pull-up node and the N^{th} stage scanning signal output end for maintaining the potentials of the N^{th} stage scanning signal output end and the pull-up node under a control of the low-frequency clock signal, the clock signal, and the reference low-level signal.

Alternatively, in some embodiments of the present application, the pull-up control module includes a first transistor;
a gate electrode of the first transistor receives the control signal or the pull-up signal, a source electrode of the first transistor receives the pull-up signal, and a drain electrode of the first transistor is connected to the pull-up node.

Alternatively, in some embodiments of the present application, the pull-up output module includes a second transistor, a third transistor, and a bootstrap capacitor;
a gate electrode of the second transistor, a gate electrode of the third transistor, and one end of the bootstrap capacitor are connected to the pull-up node; a source electrode of the second transistor and a source electrode of the third transistor both receive the clock signal; a drain electrode of the second transistor is connected to the N^{th} stage transmission signal output end, and a drain electrode of the third transistor and another end of the bootstrap capacitor are connected to the N^{th} stage scanning signal output end.

Alternatively, in some embodiments of the present application, the pull-down module includes a fourth transistor and a fifth transistor;
a gate electrode of the fourth transistor and a gate electrode of the fifth transistor both receive the (N+m)^{th} stage scanning signal, a source electrode of the fourth transistor and a source electrode of the fifth transistor both receive the reference low-level signal, a drain electrode of the fourth transistor is connected to the pull-up node, and a drain electrode of the fifth transistor is connected to the N^{th} stage scanning signal output end.

Alternatively, in some embodiments of the present application, the pull-down maintenance module includes a first pull-down maintenance unit and a second pull-down maintenance unit, and the low-frequency clock signal includes a first low-frequency clock signal and a second low-frequency clock signal;
the first pull-down maintenance unit receives the first low-frequency clock signal and the reference low-level signal and is connected to the pull-up node and the N^{th} stage scanning signal output end for maintaining the potential of the N^{th} stage scanning signal output end; and the second pull-down maintenance unit receives the second low-frequency clock signal, the reference low-level signal, and the clock signal and is connected to the pull-up node and the N^{th} stage scanning signal output end for maintaining the potentials of the pull-up node and the N^{th} stage scanning signal output end.

Alternatively, in some embodiments of the present application, the first low-frequency clock signal and the second low-frequency clock signal remain in inverse phases.

Alternatively, in some embodiments of the present application, the first low-frequency clock signal and the second low-frequency clock signal remain in a same phase.

Alternatively, in some embodiments of the present application, the first pull-down maintenance unit includes a sixth transistor, a seventh transistor, an eighth transistor, a ninth transistor, and a tenth transistor;
a gate electrode of the sixth transistor, a source electrode of the sixth transistor, and a source electrode of the seventh transistor all receive the first low-frequency clock signal, and a drain electrode of the sixth transistor, a gate electrode of the seventh transistor, and a drain electrode of the eighth transistor are connected together; a drain electrode of the seventh transistor, a drain electrode of the ninth transistor, and a gate electrode of the tenth transistor are connected to a first pull-down node, and a gate electrode of the eighth transistor and a gate electrode of the ninth transistor are connected to the pull-up node; a source electrode of the eighth transistor, a source electrode of the ninth transistor, and a source electrode of the tenth transistor all receive the reference low-level signal, and a drain electrode of the tenth transistor is connected to the N^{th} stage scanning signal output end.

Alternatively, in some embodiments of the present application, the first pull-down maintenance unit further includes a seventeenth transistor; a gate electrode of the seventeenth transistor is connected to the first pull-down node, a source electrode of the seventeenth transistor receives the reference low-level signal, and a drain electrode of the seventeenth transistor is connected to the pull-up node or the N^{th} stage transmission signal output end.

Alternatively, in some embodiments of the present application, the second pull-down maintenance unit further includes an eighteenth transistor; a gate electrode of the eighteenth transistor is connected to a second pull-down node, a source electrode of the eighteenth transistor receives the reference low-level signal, and a drain electrode of the eighteenth transistor is connected to the pull-up node or the N^{th} stage transmission signal output end.

Alternatively, in some embodiments of the present application, the second pull-down maintenance unit includes an eleventh transistor, a twelfth transistor, a thirteenth transistor, a fourteenth transistor, a fifteenth transistor, and a sixteenth transistor;
a gate electrode of the eleventh transistor, a source electrode of the eleventh transistor, and a source electrode of the twelfth transistor all receive the second low-frequency clock signal, and a drain electrode of the eleventh transistor, a gate electrode of the twelfth transistor, and a drain electrode of the thirteenth transistor are connected together; a drain electrode of the twelfth transistor, a drain electrode of the fourteenth transistor, and a gate electrode of the fifteenth transistor are connected to a second pull-down node, and a gate electrode of the thirteenth transistor and a gate electrode of the fourteenth transistor are connected to the pull-up node; a source electrode of the thirteenth transistor, a source electrode of the fourteenth transistor, and a source electrode of the fifteenth transistor all receive the reference low-level signal; a drain electrode of the fifteenth transistor is connected to a source electrode of the sixteenth transistor, a gate electrode of the sixteenth transistor receives the clock signal, and a drain electrode of the sixteenth transistor is connected to the N^{th} stage scanning signal output end.

Alternatively, in some embodiments of the present application, the first pull-down maintenance unit further includes a seventeenth transistor; a gate electrode of the seventeenth transistor is connected to the first pull-down node, a source electrode of the seventeenth transistor receives the reference low-level signal, and a drain electrode of the seventeenth transistor is connected to the pull-up node or the N^{th} stage transmission signal output end.

Alternatively, in some embodiments of the present application, the second pull-down maintenance unit further includes an eighteenth transistor; a gate electrode of the eighteenth transistor is connected to the second pull-down node, a source electrode of the eighteenth transistor receives the reference low-level signal, and a drain electrode of the eighteenth transistor is connected to the pull-up node or the N^{th} stage transmission signal output end.

Alternatively, in some embodiments of the present application, the control signal is an (N−m)^{th} stage transmission signal or an (N−m)^{th} stage scanning signal, and the pull-up signal is the (N−m)^{th} stage transmission signal, the (N−m)^{th} stage scanning signal, or a high-level direct current signal; both N and m are integers greater than 0, and N>m.

Alternatively, in some embodiments of the present application, the pull-down maintenance module includes a first pull-down maintenance unit, the low-frequency clock signal includes a first low-frequency clock signal, and the first pull-down maintenance unit receives the first low-frequency clock signal and the reference low-level signal and is connected to the pull-up node and the N^{th} stage scanning signal output end for maintaining the potential of the N^{th} stage scanning signal output end.

Alternatively, in some embodiments of the present application, the pull-down maintenance module includes a second pull-down maintenance unit, the low-frequency clock signal includes a second low-frequency clock signal, and the second pull-down maintenance unit receives the second low-frequency clock signal, the reference low-level signal, and the clock signal and is connected to the pull-up node and the N^{th} stage scanning signal output end for maintaining the potentials of the pull-up node and the N^{th} stage scanning signal output end.

The present application further provides a display panel, the display panel includes a display area and a non-display area connected to the display area, and the display panel includes a gate driver on array (GOA) circuit; the GOA circuit is located in the non-display area, and the GOA circuit outputs a plurality of scanning signals to the display area; the display panel includes a plurality of cascaded GOA units, and an N^{th} stage GOA unit includes a pull-up control module, a pull-up output module, a pull-down module, and a pull-down maintenance module;
the pull-up control module receives a control signal and a pull-up signal and is connected to a pull-up node for outputting the pull-up signal to the pull-up node under a control of the control signal and the pull-up signal;
the pull-up output module receives a clock signal and is connected to the pull-up node, an N^{th} stage scanning signal output end, and an N^{th} stage transmission signal output end for outputting an N^{th} stage scanning signal and an N^{th} stage transmission signal under a control of a potential of the pull-up node and the clock signal;
the pull-down module receives an (N+m)^{th} stage transmission signal and a reference low-level signal and is connected to the pull-up node and the N^{th} stage scanning signal output end for pulling down potentials of the pull-up node and the N^{th} stage scanning signal output end under a control of the (N+m)^{th} stage transmission signal and the reference low-level signal; and
the pull-down maintenance module receives a low-frequency clock signal, the clock signal, and the reference low-level signal and is connected to the pull-up node and the N^{th} stage scanning signal output end for maintaining the potentials of the N^{th} stage scanning signal output end and the pull-up node under a control of the low-frequency clock signal, the clock signal, and the reference low-level signal.

Alternatively, in some embodiments of the present application, the pull-down maintenance module includes a first pull-down maintenance unit and a second pull-down maintenance unit, and the low-frequency clock signal includes a first low-frequency clock signal and a second low-frequency clock signal;
the first pull-down maintenance unit includes a sixth transistor, a seventh transistor, an eighth transistor, a ninth transistor, and a tenth transistor;
a gate electrode of the sixth transistor, a source electrode of the sixth transistor, and a source electrode of the seventh transistor all receive the first low-frequency clock signal, and a drain electrode of the sixth transistor, a gate electrode of the seventh transistor, and a drain electrode of the eighth transistor are connected together; a drain electrode of the seventh transistor, a drain electrode of the ninth transistor, and a gate electrode of the tenth transistor are connected to a first pull-down node, and a gate electrode of the eighth transistor and a gate electrode of the ninth transistor are connected to the pull-up node; a source electrode of the eighth transistor, a source electrode of the ninth transistor, and a source electrode of the tenth transistor all receive the reference low-level signal, and a drain electrode of the tenth transistor is connected to the N^{th} stage scanning signal output end; and
the second pull-down maintenance unit includes an eleventh transistor, a twelfth transistor, a thirteenth transistor, a fourteenth transistor, a fifteenth transistor, and a sixteenth transistor;
a gate electrode of the eleventh transistor, a source electrode of the eleventh transistor, and a source electrode of the twelfth transistor all receive the second low-frequency clock signal, and a drain electrode of the eleventh transistor, a gate electrode of the twelfth transistor, and a drain electrode of the thirteenth transistor are connected together; a drain electrode of the twelfth transistor, a drain electrode of the fourteenth transistor, and a gate electrode of the fifteenth transistor are connected to a second pull-down node, and a gate electrode of the thirteenth transistor and a gate electrode of the fourteenth transistor are connected to the pull-up node; a source electrode of the thirteenth transistor, a source electrode of the fourteenth transistor, and a source electrode of the fifteenth transistor all receive the reference low-level signal; a drain electrode of the fifteenth transistor is connected to a source electrode of the sixteenth transistor, a gate electrode of the sixteenth transistor receives the clock signal, and a drain electrode of the sixteenth transistor is connected to the N^{th} stage scanning signal output end.

Alternatively, in some embodiments of the present application, the first low-frequency clock signal and the second low-frequency clock signal remain in inverse phases or remain in a same phase.

Alternatively, in some embodiments of the present application, the control signal is an (N−m)^{th} stage transmission signal or an (N−m)^{th} stage scanning signal, and the pull-up signal is the (N−m)^{th} stage transmission signal, the (N−m)^{th} stage scanning signal, or a high-level direct current signal; both N and m are integers greater than 0, and N>m.

The present application provides the GOA circuit and the display panel. The GOA circuit includes the plurality of cascaded GOA units, and the N^{th} stage GOA unit includes the pull-up control module, the pull-up output module, the pull-down module, and the pull-down maintenance module, which is a simple structure. Wherein the pull-down maintenance module receives the clock signal and can pull down the potential of the pull-up node under the control of the clock signal. Since the clock signal is always in a state of a conversion between a high-level and a low-level, a working time of the pull-down maintenance module can be reduced and working life of the pull-down maintenance module can be prolonged, so as to improve the working stability of the GOA circuit.

### BRIEF DESCRIPTION OF DRAWINGS

In order to clearly explain technical solutions in embodiments of the present application, the following will briefly introduce drawings needed to be used in descriptions of the embodiments. It is obvious that the drawings in the following descriptions are only some embodiments of the present application. For those skilled in the art, other drawings can be obtained according to these drawings without paying creative labor.

FIG. 1 is a first schematic structural diagram of an N^{th} stage GOA unit provided in the present application.

FIG. 2 is a first schematic circuit diagram of the N^{th} stage GOA unit shown in FIG. 1.

FIG. 3 is a signal timing sequence diagram of the N^{th} stage GOA unit provided in the present application.

FIG. 4 is a second schematic circuit diagram of the N^{th} stage GOA unit shown in FIG. 1.

FIG. 5 is a second schematic structural diagram of the N^{th} stage GOA unit provided in the present application.

FIG. 6 is a schematic circuit diagram of the N^{th} stage GOA unit shown in FIG. 5.

FIG. 7 is a schematic structural diagram of a display panel provided by the present application.

### DETAILED DESCRIPTION OF EMBODIMENTS

Technical solutions in embodiments of the present application will be described clearly and completely below in combination with attached drawings in the embodiment of the present application. Obviously, the described embodiments are only part of the embodiments of the present application, not all of the embodiments. Based on the embodiments in the present application, all other embodiments obtained by those skilled in the art without creative work belong to a scope of a protection of the present application.

In addition, terms “first”, “second” and the like in the description and claims of the present application are used to distinguish different objects, not to describe a specific order. Terms “include” and “have” and any variations thereof are intended to cover non-exclusive inclusion.

The present application provides a gate driver on array (GOA) circuit and a display panel, which will be described in detail below. It should be noted that an order of description of the following embodiments does not limit a preferred order of the embodiments of the present application.

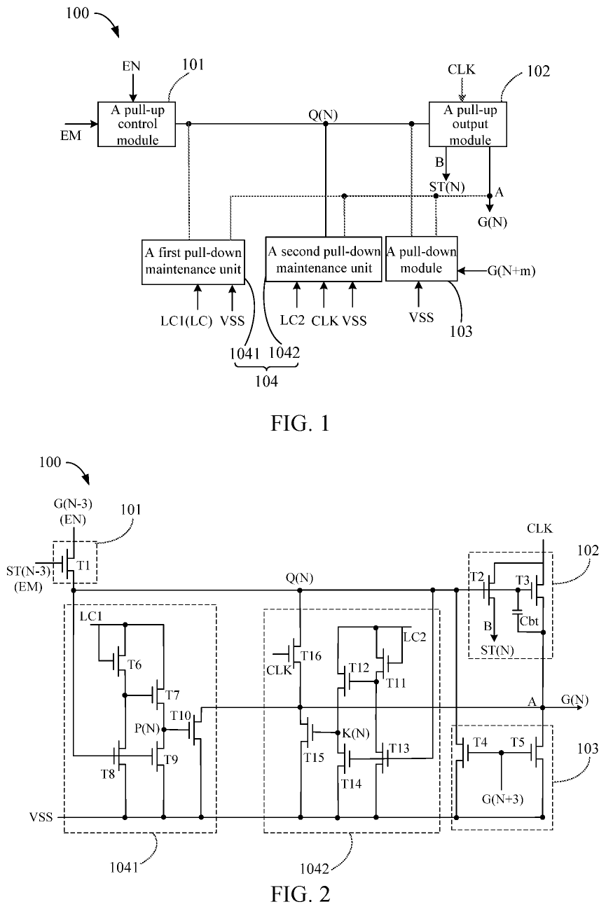

Please refer to FIG. 1, FIG. 1 is a first schematic structural diagram of an N^{th} stage GOA unit provided in the present application. In an embodiment of the present application, the GOA circuit includes a plurality of cascaded GOA units 100. The N^{th} stage GOA unit 100 includes a pull-up control module 101, a pull-up output module 102, a pull-down module 103, and a pull-down maintenance module 104.

Wherein the pull-up control module 101 receives a control signal EM and a pull-up signal EN and is connected to a pull-up node Q(N). The pull-up control module 101 is configured to output the pull-up signal EN to the pull-up node Q(N) under a control of the control signal EM and the pull-up signal EN.

It should be noted that the control signal EM can be an (N−m)^{th} stage transmission signal ST(N−m) or an (N−m)^{th} stage scanning signal G(N−m), and the pull-up signal EN can be the (N−m)^{th} stage transmission signal ST(N−m), the (N−m)^{th} stage scanning signal G(N−m), or other high-level direct current signal, so as to improve flexibility of signal connections in the GOA circuit.

That is, the pull-up control module 101 can only receive the (N−m)^{th} stage transmission signal ST(N−m). The pull-up control module 101 can also only receive the (N−m)^{th} stage scanning signal G(N−m). The pull-up control module 101 can also receive the (N−m)^{th} stage transmission signal ST(N−m) and the (N−m)^{th} stage scanning signal G(N−m) at a same time.

Of course, the pull-up control module 101 can further receive other control signals with a same timing sequence as the (N−m)^{th} stage transmission signal ST(N−m) or the (N−m)^{th} stage scanning signal G(N−m), and is not limited by the embodiment of the present application.

In addition, in the GOA circuit, for prior m-stage ones of the GOA units 100, the (N−m)^{th} stage transmission signal ST(N−m) and the (N−m)^{th} stage scanning signal G(N−m) do not exist. Therefore, in the prior m-stage ones of the GOA units 100, a start signal can be provided to replace the (N−m)^{th} stage transmission signal ST(N−m) and the (N−m)^{th} stage scanning signal G(N−m), which will not be described here. Similarly, for later m-stage ones of the GOA units 100, the (N+m)^{th} stage transmission signal ST(N+m) and the (N+m)^{th} stage scanning signal G(N+m) do not exist. Therefore, in the later m-stage ones of the GOA units 100, the start signal or another signal can also be provided to replace the (N+m)^{th} stage transmission signal ST(N−m) and the (N+m)^{th} stage scanning signal G(N−m). Alternatively, a virtual GOA unit can also be disposed in the GOA circuit. It should be noted that in addition to above differences, circuit structures and signal connections of the prior m-stage ones of the GOA units 100 and the later m-stage ones of the GOA units 100 are same as those of other stage ones of the GOA units 100, which will not be repeated here.

Wherein the pull-up output module 102 receives a clock signal CLK and is connected to the pull-up node Q(N), an N^{th} stage scanning signal output end A, and an N^{th} stage transmission signal output end B. The pull-up output module 102 outputs an N^{th} stage scanning signal G(N) and an N^{th} stage transmission signal ST(N) under a control of a potential of the pull-up node Q(N) and the clock signal CLK.

Wherein the pull-down module 103 receives the (N+m)^{th} stage transmission signal ST(N+m) and a reference low-level signal VSS and is connected to the pull-up node Q(N) and the N^{th} stage scanning signal output end A. The pull-down module 103 is configured to pull down the potentials of the pull-up node Q(N) and a potential of the N^{th} stage scanning signal output end A under a control of the (N+m)^{th} stage transmission signal ST(N+m) and the reference low-level signal VSS.

The pull-down maintenance module 104 receives a low-frequency clock signal LC, the clock signal CLK, and the reference low-level signal VSS and is connected to the pull-up node Q(N) and the N^{th} stage scanning signal output end A. The pull-down maintenance module 104 is configured to maintain the potentials of the N^{th} stage scanning signal output end A and the pull-up node Q(N) under a control of the low-frequency clock signal LC, the clock signal CLK, and the reference low-level signal VSS.

In the N^{th} stage GOA unit 100 provided by the embodiment of the present application, the pull-down maintenance module 104 receives the clock signal CLK and can pull down the potential of the pull-up node Q(N) under the control of the clock signal CLK. Since the clock signal CLK is always in a state of a conversion between high level and low level, a working time of the pull-down maintenance module 104 can be reduced and a working life of the pull-down maintenance module 104 can be prolonged, so as to improve working stability of the GOA circuit. In addition, compared with structures of GOA circuits in related technologies, the N^{th} stage GOA unit 100 provided in the embodiment of the present application has a simple structure, which can reduce a size of the GOA circuit and realize a narrow-frame design of a display panel.

Please refer to FIG. 1 and FIG. 2 at a same time. FIG. 2 is a first schematic circuit diagram of the N^{th} stage GOA unit shown in FIG. 1. It should be noted that following embodiments of the present application take m equal to 3 as an example, but it cannot be understood as a limitation of the present application.

In some embodiments of the present application, the pull-up control module 101 includes a first transistor T1. Agate electrode of the first transistor T1 is connected to the control signal EM. A source electrode of the first transistor T1 receives the pull-up signal EN. A drain electrode of the first transistor T1 is connected to the pull-up node Q(N).

Wherein the gate electrode and the source electrode of the first transistor T1 can receive one of the control signal EM and the pull-up signal EN, respectively. The gate electrode and the source electrode of the first transistor T1 can also receive a same one of the control signal EM and the pull-up signal EN at a same time. For the control signal EM and the pull-up signal EN, please refer to above contents and will not be repeated here.

Following embodiments of the present application take the gate electrode of the first transistor T1 receiving an (N−3)^{th} stage transmission signal ST(N−3) and the source electrode of the first transistor T1 receiving an (N−3)^{th} stage scanning signal G(N−3) as examples, but cannot be understood as a limitation of the present application.

In some embodiments of the present application, the pull-up output module 102 includes a second transistor T2, a third transistor T3, and a bootstrap capacitor Cbt.

Wherein a gate electrode of the second transistor T2, a gate electrode of the third transistor T3, and one end of the bootstrap capacitor Cbt are connected to the pull-up node Q(N). A source electrode of the second transistor T2 and a source electrode of the third transistor T3 both receive the clock signal CLK. A drain electrode of the second transistor T2 is connected to the N^{th} stage transmission signal output end B. A drain electrode of the third transistor T3 and another end of the bootstrap capacitor Cbt are both connected to the N^{th} stage scanning signal output end A.

In some embodiments of the present application, the pull-down module 103 includes a fourth transistor T4 and a fifth transistor T5.

Wherein a gate electrode of the fourth transistor T4 and a gate electrode of the fifth transistor T5 are connected to an (N+3)^{th} stage scanning signal G(N+3). A source electrode of the fourth transistor T4 and a source electrode of the fifth transistor T5 both receive the reference low-level signal VSS. A drain electrode of the fourth transistor T4 is connected to the pull-up node Q(N). A source electrode of the fifth transistor T5 is connected to the N^{th} stage scanning signal output end A.

In some embodiments of the present application, the pull-down maintenance module 104 includes a first pull-down maintenance unit 1041 and a second pull-down maintenance unit 1042. The low-frequency clock signal LC includes a first low-frequency clock signal LC1 and a second low-frequency clock signal LC2.

Wherein the first pull-down maintenance unit 1041 receives the first low-frequency clock signal LC1 and the reference low-level signal VSS and is connected to the pull-up node Q(N) and the N^{th} stage scanning signal output end A. The first pull-down maintenance unit 1041 is configured to maintain the potential of the N^{th} stage scanning signal output end A. The second pull-down maintenance unit 1042 receives the second low-frequency clock signal LC2, the reference low-level signal VSS, and the clock signal CLK and is connected to the pull-up node Q(N) and the N^{th} stage scanning signal output end A. The second pull-down maintenance unit 1042 is configured to maintain the potentials of the pull-up node Q(N) and the N^{th} stage scanning signal output end A.

Wherein the first low-frequency clock signal LC1 and the second low-frequency clock signal LC2 remain in inverse phases. When the first low-frequency clock signal LC1 is at high level, the second low-frequency clock signal LC2 is at low level. When the first low-frequency clock signal LC1 is at low level, the second low-frequency clock signal LC2 is at high level. In this way, the first pull-down maintenance unit 1041 and the second pull-down maintenance unit 1042 can work alternately to prolong service life of the first pull-down maintenance unit 1041 and the second pull-down maintenance unit 1042. Of course, in order to improve stability of pulling down, the first low-frequency clock signal LC1 and the second low-frequency clock signal LC2 can also remain in a same phase, so that the first pull-down maintenance unit 1041 and the second pull-down maintenance unit 1042 can work at a same time.

Of course, in some embodiments of the present application, the pull-down maintenance module 104 can only include the first pull-down maintenance unit 1041. In other embodiments of the present application, the pull-down maintenance module 104 can only include the second pull-down maintenance unit 1042. Thus, structures of the GOA units 100 can be further simplified, so as to reduce the size of the GOA circuit.

In some embodiments of the present application, the first pull-down maintenance unit 1041 includes a sixth transistor T6, a seventh transistor T7, an eighth transistor T8, a ninth transistor T9, and a tenth transistor T10.

Wherein a gate electrode of the sixth transistor T6, a source electrode of the sixth transistor T6, and a source electrode of the seventh transistor T7 all receive the first low-frequency clock signal LC1. A drain electrode of the sixth transistor T6, a gate electrode of the seventh transistor T7, and a drain electrode of the eighth transistor T8 are connected together. A drain electrode of the seventh transistor T7, a drain electrode of the ninth transistor T9, and a gate electrode of the tenth transistor T10 are connected to a first pull-down node P(N). A gate electrode of the eighth transistor T8 and a gate electrode of the ninth transistor T9 are connected to the pull-up node Q(N). A source electrode of the eighth transistor T8, a source electrode of the ninth transistor T9, and a source electrode of the tenth transistor T10 all receive the reference low-level signal VSS. A drain electrode of the tenth transistor T10 is connected to the N^{th} stage scanning signal output end A.

In some embodiments of the present application, the second pull-down maintenance unit 1042 includes an eleventh transistor T11, a twelfth transistor T12, a thirteenth transistor T13, a fourteenth transistor T14, a fifteenth transistor T15, and a sixteenth transistor T16.

Wherein a gate electrode of the eleventh transistor T11, a source electrode of the eleventh transistor T11, and a source electrode of the twelfth transistor T12 all receive the second low-frequency clock signal LC2. A drain electrode of the eleventh transistor T11, a gate electrode of the twelfth transistor T12, and a drain electrode of the thirteenth transistor T13 are connected together. A drain electrode of the twelfth transistor T12, a drain electrode of the fourteenth transistor T14, and a gate electrode of the fifteenth transistor T15 are connected to a second pull-down node K(N). A gate electrode of the thirteenth transistor T13 and a gate electrode of the fourteenth transistor T14 are connected to the pull-up node Q(N). A source electrode of the thirteenth transistor T13, a source electrode of the fourteenth transistor T14, and a source electrode of the fifteenth transistor T15 all receive the reference low-level signal VSS. A drain electrode of the fifteenth transistor T15 is connected to a source electrode of the sixteenth transistor T16. A gate electrode of the sixteenth transistor T16 receives the clock signal CLK. A drain electrode of the sixteenth transistor T16 is connected to the N^{th} stage scanning signal output end A.

It is understandable that in order to reduce production cost, display panels in related technologies will adopt a tri-gate structure. Compared with traditional pixel structures, the tri-gate structure disposes sub-pixel units by a mode of rotating all of the sub-pixel units by 90 degrees. For example, when the sub-pixel units are arranged in an RGB structure, a number of scanning lines is increased by three times and a number of data lines is reduced to ⅓ of original ones. In this way, a number of driver chips can be reduced and the production cost can be reduced. However, with an increase of a number of GOA units, a wiring space occupied by a GOA circuit structure becomes larger, which is not conducive to realizing the narrow-frame design of the display panels.

In the embodiment of the present application, the N^{th} stage GOA unit 100 only includes sixteen transistors and one bootstrap capacitor (16T1C), which is a simple structure, and a number of transistors is less. Therefore, the size of the GOA circuit can be effectively reduced and it is convenient to realize the narrow-frame design of the display panel.

It should be noted that the transistors used in all embodiments of the present application can be thin film transistors, field effect transistors, or other devices with same characteristics. Since the source electrode and the drain electrode of the transistors used here are symmetrical, the source electrode and the drain electrode of the transistors can be interchanged. In the embodiment of the present application, in order to distinguish two electrodes of the transistors except for the gate electrode, one of the two electrodes is called the source electrode and another of the two electrodes is called the drain electrode. According to a configuration in attached figures, a middle end of a switching transistor is the gate electrode, a signal input end is the source electrode, and a signal output end is the drain electrode. In addition, the transistors used in the embodiment of the present application can include P-type transistors and/or N-type transistors, wherein the P-type transistors are on when the gate electrode is at low level and cut off when the gate electrode is at high level, and the N-type transistors are on when the gate electrode is at high level and cut off when the gate electrode is at low level.

In addition, the transistors in following embodiments of the present application are illustrated by taking the N-type transistors as an example, but it cannot be understood as a limitation of the present application.

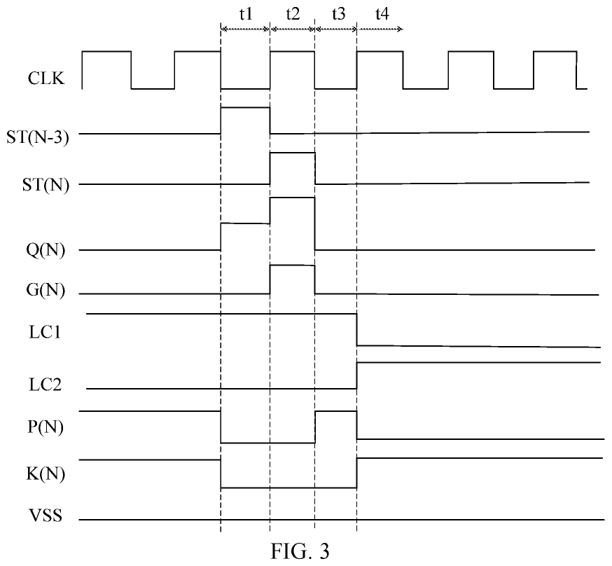

Please refer to FIG. 2 and FIG. 3 at a same time, FIG. 3 is a signal timing sequence diagram of the N^{th} stage GOA unit provided in the present application. In the embodiment of the present application, a working timing sequence of the N^{th} stage GOA unit 100 includes a pull-up stage t1, a signal output stage t2, a pull-down stage t3, and a pull-down maintenance stage t4.

In the pull-up stage t1, the (N−3)^{th} stage transmission signal ST(N−3) is at high level. The first transistor T1 is turned on under a control of the (N−3)^{th} stage transmission signal ST(N−3). The (N−3)^{th} stage scanning signal G(N−3) is transmitted to the pull-up node Q(N) through the first transistor T1. Since the (N−3)^{th} stage scanning signal G(N−3) is at high level, the potential of the pull-up node Q(N) is pulled up, then the second transistor T2 and the third transistor T3 are turned on. At this time, since the clock signal CLK is at low level, the N^{th} stage transmission signal ST(N) and the N^{th} stage scanning signal G(N) are both at low level.

At a same time, in the first pull-down maintenance unit 1041, since the (N−3)^{th} stage scanning signal G(N−3) is at the high level, the eighth transistor T8 and the ninth transistor T9 are turned on. The reference low-level signal VSS is transmitted to the gate electrode of the seventh transistor T7 and the first pull-down node P(N). The seventh transistor T7 is in an off state. A potential of the first pull-down node P(N) is pulled down. The tenth transistor T10 is turned off.

In the second pull-down maintenance unit 1042, since the (N−3)^{th} stage scanning signal G(N−3) is at high level, the thirteenth transistor T13 and the fourteenth transistor T14 are turned on. The reference low-level signal VSS is transmitted to the gate electrode of the twelfth transistor T12 and the second pull-down node K(N). The twelfth transistor T12 is in an off state. A potential of the second pull-down node K(N) is pulled down. The fifteenth transistor T15 is turned off.

In the signal output stage t2, the clock signal CLK changes to be at high level. The potential of the pull-up node Q(N) is further pulled up under an action of the bootstrap capacitor Cbt and the clock signal CLK. The second transistor T2 and the third transistor T3 are fully turned on, and the clock signal CLK is output through the second transistor T2 and the third transistor T3, respectively, which has a small loss. Therefore, the N^{th} stage transmission signal ST(N) and the N^{th} stage scanning signal G(N) are both at high level.

At this time, the first pull-down maintenance unit 1041 and the second pull-down maintenance unit 1042 are basically maintained in a state at the pull-up stage t1. Differences are that the sixteenth transistor T16 is turned on under a control of the clock signal CLK and the potential of the pull-up node Q(N) is transmitted to the N^{th} stage scanning signal output end A, which can enhance an output of the N^{th} stage scanning signal G(N) and improve charging capacity of corresponding ones of scanning lines.

In the pull-down stage t3, the (N+3)^{th} stage scanning signal G(N+3) is at high level, and the fourth transistor T4 and the fifth transistor T5 are turned on. The potential of the pull-up node Q(N) and the potential of the N^{th} stage scanning signal G(N) are pulled down to the reference low-level signal VSS to realize a resetting of the N^{th} stage scanning signal G(N).

At this time, since the potential of the pull-up node Q(N) is pulled down, the eighth transistor T8 and the ninth transistor T9 are turned off. The first low-frequency clock signal LC1 remains at high level, and the sixth transistor T6 and the seventh transistor T7 are both turned on. The potential of the first pull-down node P(N) is pulled up. The tenth transistor T10 is turned on, which can further pull down the N^{th} stage scanning signal G(N). Similarly, the eleventh transistor T11 and the twelfth transistor T12 are turned off. However, since the second low-frequency clock signal LC2 remains at low level, the potential of the second pull-down node K(N) remains at low level.

In the pull-down maintenance stage t4, the first low-frequency clock signal LC1 changes to be at low level and the second low-frequency clock signal LC2 changes to be at high level. The potential of the first pull-down node P(N) is pulled down and the potential of the second pull-down node K(N) is pulled up. The fifteenth transistor T15 is turned on to further maintain a low potential of the N^{th} stage scanning signal G(N).

At this stage, the clock signal CLK is always in the state of the conversion between high level and low level. Therefore, the sixteenth transistor T16 is in a state of being turned on alternately to indirectly maintain the potential of the pull-up node Q(N). Thus, a working time of the sixteenth transistor T16 can be reduced and bias voltages can be reduced, so as to improve service life of the sixteenth transistor T16. In addition, compared with maintaining a low potential of a pull-up node by disposing a transistor controlled by a pull-down node of a pull-down maintenance module of the existing GOA units, the embodiment of the present application can prolong service life of the second pull-down maintenance unit 1042 by prolonging working life of the sixteenth transistor T16.

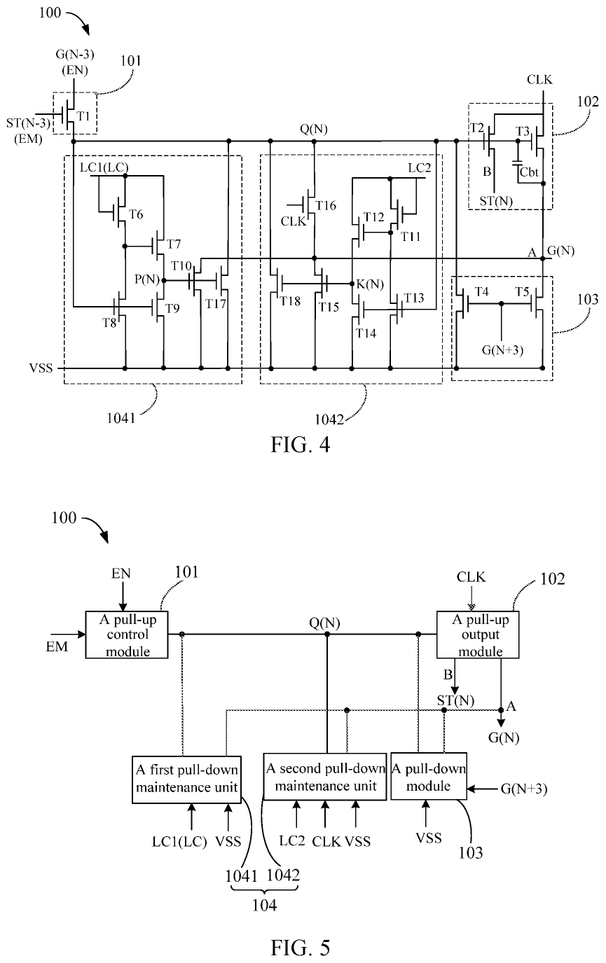

Please refer to FIG. 4, FIG. 4 is a second schematic circuit diagram of the N^{th} stage GOA unit shown in FIG. 1. Differences from the N^{th} stage GOA unit 100 shown in FIG. 1 are that in an embodiment of the present application, the first pull-down maintenance unit 1041 further includes a seventeenth transistor T17; a gate electrode of the seventeenth transistor T17 is connected to the first pull-down node P(N), a source electrode of the seventeenth transistor T17 receives the reference low-level signal VSS, and a drain electrode of the seventeenth transistor T17 is connected to the pull-up node Q(N).

Combining FIG. 3 and above analysis, in the pull-down stage t3, the seventeenth transistor T17 is turned on under a control of the first pull-down node P(N). The reference low-level signal VSS is transmitted to the pull-up node Q(N) through the seventeenth transistor T17 to further pull down the potential of the pull-up node Q(N) to prevent erroneous output of scanning signals.

Further, in some embodiments of the present application, the second pull-down maintenance unit 1042 further includes an eighteenth transistor T18. A gate electrode of the eighteenth transistor T18 is connected to the second pull-down node K(N). A source electrode of the eighteenth transistor T18 receives the reference low-level signal VSS. A drain electrode of the eighteenth transistor T18 is connected to the pull-up node Q(N).

Combining FIG. 3 and above analysis, in the pull-down maintenance stage t4, the eighteenth transistor T18 is turned on under a control of the second pull-down node K(N). The reference low-level signal VSS is transmitted to the pull-up node Q(N) through the eighteenth transistor T18 to further pull down the potential of the pull-up node Q(N) to prevent erroneous output of the scanning signals.

Please refer to FIG. 5. FIG. 5 is a second schematic structural diagram of the N^{th} stage GOA unit provided in the present application. Differences from the N^{th} stage GOA unit 100 shown in FIG. 1 are that in the embodiment of the present application, the pull-down maintenance module 104 is further connected to the N^{th} stage transmission signal output end B, and the pull-down maintenance module 104 is further configured to pull down a potential of the N^{th} stage transmission signal output end B under an action of the low-frequency clock signal LC.

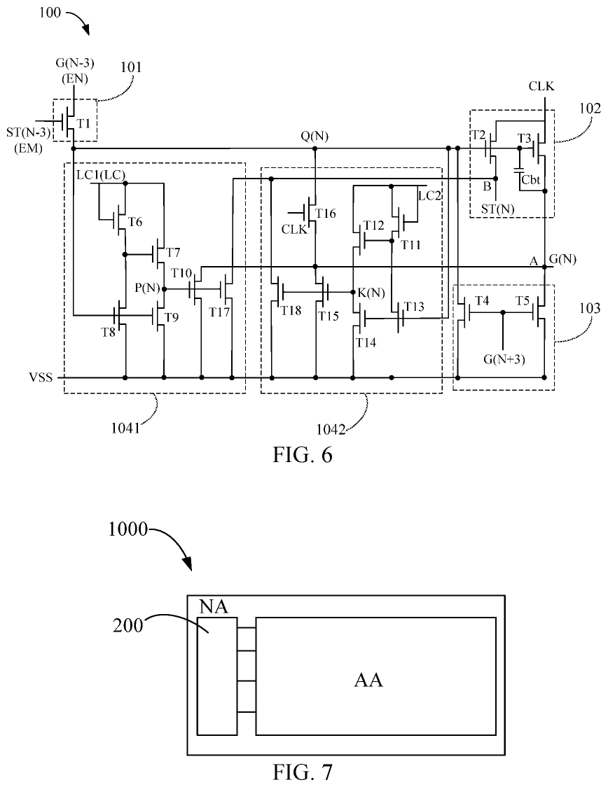

Specifically, please refer to FIG. 6. FIG. 6 is a schematic circuit diagram of the N^{th} stage GOA unit shown in FIG. 5. In an embodiment of the present application, a gate electrode of a seventeenth transistor T17 is connected to the first pull-down node P(N). A source electrode of the seventeenth transistor T17 receives the reference low-level signal VSS. A drain electrode of the seventeenth transistor T17 is connected to the N^{th} stage transmission signal output end B.

Combining FIG. 3 and above analysis, in the pull-down stage t3, the seventeenth transistor T17 is turned on under a control of the first pull-down node P(N). The reference low-level signal VSS can be transmitted to the N^{th} stage transmission signal output end B through the seventeenth transistor T17 to pull down the potential of the N^{th} stage transmission signal output end B.

Further, in some embodiments of the present application, the second pull-down maintenance unit 1042 further includes an eighteenth transistor T18. A gate electrode of the eighteenth transistor T18 is connected to the second pull-down node K(N). A source electrode of the eighteenth transistor T18 receives the reference low-level signal VSS. A drain electrode of the eighteenth transistor T18 is connected to the N^{th} stage transmission signal output end B.

Combining FIG. 3 and above analysis, in the pull-down maintenance stage t4, the eighteenth transistor T18 is turned on under a control of the second pull-down node K(N). The reference low-level signal VSS can be transmitted to the N^{th} stage transmission signal output end B through the eighteenth transistor T18 to pull down the potential of the N^{th} stage transmission signal output end B.

It can be understood that if the potential of the N^{th} stage transmission signal output end B is not pulled down, the N^{th} stage transmission signal output end B will be in a floating state for a long time, resulting great fluctuation in a high-temperature simulation, which is a great hidden danger. In the embodiment of the present application, by adding the seventeenth transistor T17 and/or the eighteenth transistor T18 in the pull-down maintenance module 104, the pull-down maintenance module 104 can continuously pull down the N^{th} stage transmission signal output end B, so as to increase reliability of the N^{th} stage transmission signal ST(N).

Of course, in an embodiment of the present application, the potential of the pull-up node Q(N) can be pulled down by one of the seventeenth transistor T17 and the eighteenth transistor T18, and the potential of the N^{th} stage transmission signal output end B can be pulled down by another one of the seventeenth transistor T17 and the eighteenth transistor T18, and is not limited by the present application.

Accordingly, the present application further provides a display panel, and the display panel includes the GOA circuit described in any of above embodiments. Specifically, please refer to FIG. 7, FIG. 7 is a schematic structural diagram of the display panel provided by the present application. As shown in FIG. 7, the display panel 1000 includes a display area AA and a non-display area NA connected to the display area AA. The GOA circuit 200 is integrated and disposed in the non-display area NA. Wherein a structure and a principle of the GOA circuit 200 are similar to the above GOA circuit, and will not be repeated here. It should be noted that the display panel 1000 provided in the present application takes a unilateral driving method of the GOA circuit 200 disposed on one side of the display area AA as an example, but it cannot be understood as a limitation of the present application. In some embodiments, bilateral driving or other driving methods can also be adopted according to actual requirements of the display panel 1000, and is not specifically limited by the present application.

In the display panel provided by the embodiment of the present application, the GOA unit includes the pull-up control module, the pull-up output module, the pull-down module, and the pull-down maintenance module, which is a simple structure. Wherein the pull-down maintenance module receives the clock signal and can pull down the potential of the pull-up node under the control of the clock signal. Since the clock signal is always in the state of the conversion between high level and low level, the working time of the pull-down maintenance module can be reduced and the working life of the pull-down maintenance module can be prolonged, so as to improve the working stability of the GOA circuit 200. In addition, compared with GOA circuit structures in related technologies, the embodiment of the present application can reduce the number of the transistors in the GOA unit, thereby reducing the size of the GOA circuit 200, realizing a narrow-frame design of the display panel 1000, and making the display panel 1000 suitable for a tri-gate structure.

The above describes the GOA circuit and the display panel in the embodiments of the present application in detail. In this paper, specific examples are applied to explain a principle and implementation modes of the present application. The descriptions of the above embodiments are only used to help understand a method and a core idea of the present application; at a same time, for those skilled in the art, there will be changes in the specific implementation modes and an application scope according to the idea of the present application. In conclusion, contents of the specification should not be understood as restrictions on the present application.

What is claimed is:

1. A gate driver on array (GOA) circuit, comprising a plurality of cascaded GOA units, and an N^{th} stage GOA unit comprising a pull-up control module, a pull-up output module, a pull-down module, and a pull-down maintenance module;
the pull-up control module receives a control signal and a pull-up signal and is connected to a pull-up node for outputting the pull-up signal to the pull-up node under a control of the control signal and the pull-up signal;
the pull-up output module receives a clock signal and is connected to the pull-up node, an N^{th} stage scanning signal output end, and an N^{th} stage transmission signal output end for outputting an N^{th} stage scanning signal and an N^{th} stage transmission signal under a control of a potential of the pull-up node and the clock signal;
the pull-down module receives an (N+m)^{th} stage transmission signal and a reference low-level signal and is connected to the pull-up node and the N^{th} stage scanning signal output end for pulling down potentials of the pull-up node and the N^{th} stage scanning signal output end under a control of the (N+m)^{th} stage transmission signal and the reference low-level signal; and
the pull-down maintenance module receives a low-frequency clock signal, the clock signal, and the reference low-level signal and is connected to the pull-up node and the N^{th} stage scanning signal output end for maintaining the potentials of the N^{th} stage scanning signal output end and the pull-up node under a control of the low-frequency clock signal, the clock signal, and the reference low-level signal.

2. The GOA circuit according to claim 1, wherein the pull-up control module comprises a first transistor;
a gate electrode of the first transistor receives the control signal or the pull-up signal, a source electrode of the first transistor receives the pull-up signal, and a drain electrode of the first transistor is connected to the pull-up node.

3. The GOA circuit according to claim 1, wherein the pull-up output module comprises a second transistor, a third transistor, and a bootstrap capacitor;
a gate electrode of the second transistor, a gate electrode of the third transistor, and one end of the bootstrap capacitor are connected to the pull-up node; a source electrode of the second transistor and a source electrode of the third transistor both receive the clock signal; a drain electrode of the second transistor is connected to the N^{th} stage transmission signal output end, and a drain electrode of the third transistor and another end of the bootstrap capacitor are connected to the N^{th} stage scanning signal output end.

4. The GOA circuit according to claim 1, wherein the pull-down module comprises a fourth transistor and a fifth transistor;
a gate electrode of the fourth transistor and a gate electrode of the fifth transistor both receive the (N+m)^{th} stage scanning signal, a source electrode of the fourth transistor and a source electrode of the fifth transistor both receive the reference low-level signal, a drain electrode of the fourth transistor is connected to the pull-up node, and a drain electrode of the fifth transistor is connected to the N^{th} stage scanning signal output end.

5. The GOA circuit according to claim 1, wherein the pull-down maintenance module comprises a first pull-down maintenance unit and a second pull-down maintenance unit, and the low-frequency clock signal comprises a first low-frequency clock signal and a second low-frequency clock signal;
the first pull-down maintenance unit receives the first low-frequency clock signal and the reference low-level signal and is connected to the pull-up node and the N^{th} stage scanning signal output end for maintaining the potential of the N^{th} stage scanning signal output end; and the second pull-down maintenance unit receives the second low-frequency clock signal, the reference low-level signal, and the clock signal and is connected to the pull-up node and the N^{th} stage scanning signal output end for maintaining the potentials of the pull-up node and the N^{th} stage scanning signal output end.

6. The GOA circuit according to claim 5, wherein the first low-frequency clock signal and the second low-frequency clock signal remain in inverse phases.

7. The GOA circuit according to claim 5, wherein the first low-frequency clock signal and the second low-frequency clock signal remain in a same phase.

8. The GOA circuit according to claim 5, wherein the first pull-down maintenance unit comprises a sixth transistor, a seventh transistor, an eighth transistor, a ninth transistor, and a tenth transistor;
a gate electrode of the sixth transistor, a source electrode of the sixth transistor, and a source electrode of the seventh transistor all receive the first low-frequency clock signal, and a drain electrode of the sixth transistor, a gate electrode of the seventh transistor, and a drain electrode of the eighth transistor are connected together; a drain electrode of the seventh transistor, a drain electrode of the ninth transistor, and a gate electrode of the tenth transistor are connected to a first pull-down node, and a gate electrode of the eighth transistor and a gate electrode of the ninth transistor are connected to the pull-up node; a source electrode of the eighth transistor, a source electrode of the ninth transistor, and a source electrode of the tenth transistor all receive the reference low-level signal, and a drain electrode of the tenth transistor is connected to the N^{th} stage scanning signal output end.

9. The GOA circuit according to claim 8, wherein the first pull-down maintenance unit further comprises a seventeenth transistor; a gate electrode of the seventeenth transistor is connected to the first pull-down node, a source electrode of the seventeenth transistor receives the reference low-level signal, and a drain electrode of the seventeenth transistor is connected to the pull-up node or the N^{th} stage transmission signal output end.

10. The GOA circuit according to claim 8, wherein the second pull-down maintenance unit further comprises an eighteenth transistor; a gate electrode of the eighteenth transistor is connected to a second pull-down node, a source electrode of the eighteenth transistor receives the reference low-level signal, and a drain electrode of the eighteenth transistor is connected to the pull-up node or the N^{th} stage transmission signal output end.

11. The GOA circuit according to claim 8, wherein the second pull-down maintenance unit comprises an eleventh transistor, a twelfth transistor, a thirteenth transistor, a fourteenth transistor, a fifteenth transistor, and a sixteenth transistor;
a gate electrode of the eleventh transistor, a source electrode of the eleventh transistor, and a source electrode of the twelfth transistor all receive the second low-frequency clock signal, and a drain electrode of the eleventh transistor, a gate electrode of the twelfth transistor, and a drain electrode of the thirteenth transistor are connected together; a drain electrode of the twelfth transistor, a drain electrode of the fourteenth transistor, and a gate electrode of the fifteenth transistor are connected to a second pull-down node, and a gate electrode of the thirteenth transistor and a gate electrode of the fourteenth transistor are connected to the pull-up node; a source electrode of the thirteenth transistor, a source electrode of the fourteenth transistor, and a source electrode of the fifteenth transistor all receive the reference low-level signal; a drain electrode of the fifteenth transistor is connected to a source electrode of the sixteenth transistor, a gate electrode of the sixteenth transistor receives the clock signal, and a drain electrode of the sixteenth transistor is connected to the N^{th} stage scanning signal output end.

12. The GOA circuit according to claim 11, wherein the first pull-down maintenance unit further comprises a seventeenth transistor; a gate electrode of the seventeenth transistor is connected to the first pull-down node, a source electrode of the seventeenth transistor receives the reference low-level signal, and a drain electrode of the seventeenth transistor is connected to the pull-up node or the N^{th} stage transmission signal output end.

13. The GOA circuit according to claim 11, wherein the second pull-down maintenance unit further comprises an eighteenth transistor; a gate electrode of the eighteenth transistor is connected to the second pull-down node, a source electrode of the eighteenth transistor receives the reference low-level signal, and a drain electrode of the eighteenth transistor is connected to the pull-up node or the N^{th} stage transmission signal output end.

14. The GOA circuit according to claim 1, wherein the control signal is an (N−m)^{th} stage transmission signal or an (N−m)^{th} stage scanning signal, and the pull-up signal is the (N−m)^{th} stage transmission signal, the (N−m)^{th} stage scanning signal, or a high-level direct current signal; both N and m are integers greater than 0, and N>m.

15. The GOA circuit according to claim 1, wherein the pull-down maintenance module comprises a first pull-down maintenance unit, the low-frequency clock signal comprises a first low-frequency clock signal, and the first pull-down maintenance unit receives the first low-frequency clock signal and the reference low-level signal and is connected to the pull-up node and the N^{th} stage scanning signal output end for maintaining the potential of the N^{th} stage scanning signal output end.

16. The GOA circuit according to claim 1, wherein the pull-down maintenance module comprises a second pull-down maintenance unit, the low-frequency clock signal comprises a second low-frequency clock signal, and the second pull-down maintenance unit receives the second low-frequency clock signal, the reference low-level signal, and the clock signal and is connected to the pull-up node and the N^{th} stage scanning signal output end for maintaining the potentials of the pull-up node and the N^{th} stage scanning signal output end.

17. A display panel, wherein the display panel comprises a display area and a non-display area connected to the display area, and the display panel comprises a gate driver on array (GOA) circuit; the GOA circuit is located in the non-display area, and the GOA circuit outputs a plurality of scanning signals to the display area; the display panel comprises a plurality of cascaded GOA units, and an N^{th} stage GOA unit comprises a pull-up control module, a pull-up output module, a pull-down module, and a pull-down maintenance module;
the pull-up control module receives a control signal and a pull-up signal and is connected to a pull-up node for outputting the pull-up signal to the pull-up node under a control of the control signal and the pull-up signal;
the pull-up output module receives a clock signal and is connected to the pull-up node, an N^{th} stage scanning signal output end, and an N^{th} stage transmission signal output end for outputting an N^{th} stage scanning signal and an N^{th} stage transmission signal under a control of a potential of the pull-up node and the clock signal;
the pull-down module receives an (N+m)^{th} stage transmission signal and a reference low-level signal and is connected to the pull-up node and the N^{th} stage scanning signal output end for pulling down potentials of the pull-up node and the N^{th} stage scanning signal output end under a control of the (N+m)^{th} stage transmission signal and the reference low-level signal; and
the pull-down maintenance module receives a low-frequency clock signal, the clock signal, and the reference low-level signal and is connected to the pull-up node and the N^{th} stage scanning signal output end for maintaining the potentials of the N^{th} stage scanning signal output end and the pull-up node under a control of the low-frequency clock signal, the clock signal, and the reference low-level signal.

18. The display panel according to claim 17, wherein the pull-down maintenance module comprises a first pull-down maintenance unit and a second pull-down maintenance unit, and the low-frequency clock signal comprises a first low-frequency clock signal and a second low-frequency clock signal;
the first pull-down maintenance unit comprises a sixth transistor, a seventh transistor, an eighth transistor, a ninth transistor, and a tenth transistor;
a gate electrode of the sixth transistor, a source electrode of the sixth transistor, and a source electrode of the seventh transistor all receive the first low-frequency clock signal, and a drain electrode of the sixth transistor, a gate electrode of the seventh transistor, and a drain electrode of the eighth transistor are connected together; a drain electrode of the seventh transistor, a drain electrode of the ninth transistor, and a gate electrode of the tenth transistor are connected to a first pull-down node, and a gate electrode of the eighth transistor and a gate electrode of the ninth transistor are connected to the pull-up node; a source electrode of the eighth transistor, a source electrode of the ninth transistor, and a source electrode of the tenth transistor all receive the reference low-level signal, and a drain electrode of the tenth transistor is connected to the N^{th} stage scanning signal output end; and
the second pull-down maintenance unit comprises an eleventh transistor, a twelfth transistor, a thirteenth transistor, a fourteenth transistor, a fifteenth transistor, and a sixteenth transistor;
a gate electrode of the eleventh transistor, a source electrode of the eleventh transistor, and a source electrode of the twelfth transistor all receive the second low-frequency clock signal, and a drain electrode of the eleventh transistor, a gate electrode of the twelfth transistor, and a drain electrode of the thirteenth transistor are connected together; a drain electrode of the twelfth transistor, a drain electrode of the fourteenth transistor, and a gate electrode of the fifteenth transistor are connected to a second pull-down node, and a gate electrode of the thirteenth transistor and a gate electrode of the fourteenth transistor are connected to the pull-up node; a source electrode of the thirteenth transistor, a source electrode of the fourteenth transistor, and a source electrode of the fifteenth transistor all receive the reference low-level signal; a drain electrode of the fifteenth transistor is connected to a source electrode of the sixteenth transistor, a gate electrode of the sixteenth transistor receives the clock signal, and a drain electrode of the sixteenth transistor is connected to the N^{th} stage scanning signal output end.

19. The display panel according to claim 18, wherein the first low-frequency clock signal and the second low-frequency clock signal remain in inverse phases or remain in a same phase.

20. The display panel according to claim 17, wherein the control signal is an (N-m)^{th} stage transmission signal or an (N−m)^{th} stage scanning signal, and the pull-up signal is the (N−m)^{th} stage transmission signal, the (N−m)^{th} stage scanning signal, or a high-level direct current signal; both N and m are integers greater than 0, and N>m.
